(19) United States
(12) Patent Application Publication
(10) Pub. No.: US 2012/0312938 A1
(43) Pub. Date: Dec. 13, 2012

(54) SINGLE-LEG DEPOSIT SURFACE WITH CUP HOLDER FOR A SANDY SUBSURFACE

(76) Inventors: Annette Auracher, Munich (DE); André Gruenewald, Munich (DE)

(21) Appl. No.: 13/514,448

(22) PCT Filed: Dec. 10, 2010
(86) PCT No.: PCT/EP2010/069366

§ 371 Date: Aug. 14, 2012

(30) Foreign Application Priority Data
Dec. 14, 2009 (DE) 20 2009 016 886.7
Aug. 3, 2010 (DE) 10 2010 036 823.7

(51) Int. Cl. A47G 23/02; F16M 11/04; F16M 11/22; A45F 3/44

(52) U.S. Cl. 248/146

(57) ABSTRACT

The invention relates to an individually positionable deposit surface as a cup holder above a sandy subsurface, including a two-part system, wherein a substantially straight mandrel is provided, which includes an upper and a lower section. The lower section is adapted for turning or inserting into the sandy subsurface. At a certain height above the lower section the straight mandrel has a cross-shaped structure that is suitable as a support for a tray-like deposit surface. The tray-like deposit surface includes an opening that is slid over the upper section of the mandrel so as to rest on and be fixable to the cross-shaped structure.

The invention relates to an individually positionable deposit facility and its components. The deposit facility can be positioned on a sandy subsurface, e.g. on beaches.

### PREVIOUS OPTIONS (PRIOR ART)

Personal objects and drinking vessels (in most cases only plastic cups with and without drinking straw are allowed due to the risks of breakage and injury associated therewith) and ashtrays are placed next to the loungers. Due to the condensed water formed on the outside of the cups, sand adheres to the drinking vessels and the standing position is highly insecure.

Small tables made of plastic material matched to the dimensions of the lounger. The objects (plastic cups, ashtrays and the like) deposited and placed thereon have an insecure standing position due to floor unevenness (table not standing straight) and the possibility of bumping into the table. Moreover, they are subject to wind and are blown off the table when empty due to their low empty weight.

A tray-shaped deposit means mounted directly to the sunshade. Also in this case, there is the risk of drinking vessels falling off due to wind. Furthermore, this position is highly uncomfortable since one always has to rise from the lounger when intending to drink.

In addition, all three known options have the same basic problems: In most cases the drinking vessels are left behind by the beach goer just as carelessly as the cigarette ends stuck into the sand. The cups are driven across the beach and cigarette ash is blown out of the ashtrays by the wind.

This involves a significant cleaning effort for the beach keeper which is ensured by both service staff and machines (tractor-like cleaning vehicles).

It is the object of the invention to provide an individually positionable deposit facility having a safe standing position on a sandy subsurface on which the placement or accommodation of objects, drinking vessels and the like or a safe disposal option for e.g. tobacco products is ensured in a manner easy to service.

The system according to the invention may be made of one piece (claim 9) or of two pieces which can be assembled (claim 1 or claim 11). One aspect of the invention is a method of operation (claim 17). The components of the single-leg deposit means (claim 1) or the individually positionable deposit means (claim 11) comprise the tray-shaped deposit means (claim 18) and the substantially straight mandrel (claim 22).

It is referred to the independent claims. They are incorporated herein.

The object is achieved by a single-leg deposit means (claim 1), which serves as a cup holder, wherein the cup is supported above the sandy subsurface. The single-leg deposit means is provided with a substantially straight mandrel having an upper and a lower section. The lower section can be turned into the subsurface or is inserted into the subsurface. The straight mandrel comprises a support structure at a specific height where the lower section ends (claim 11), said support structure having, for example, is the shape of a cross (claim 12). The support structure is adapted for supporting a tray-like deposit means. The supporting involves the resting of the tray on the support structure.

In order to be able to connect the tray-like deposit means with the mandrel, an opening is provided in this deposit means, which opening is guided over the upper section of the mandrel. The guiding moves the deposit means towards the support structure on which is the tray rests. It may be fixed thereto which is achieved due to the configuration of the support structure. For example, the fixing is achieved due to a downward facing edge provided on the tray (claim 5), which edge is adapted to a cross-shaped structure (claim 4).

If the mandrel is turned into a sandy subsurface, a spiral can be provided (claim 2). In order to achieve or facilitate or enable the turning in at all, the cross-shaped support structure may serve as a grab handle by means of which the user inserts or turns the mandrel into the subsurface (claim 3).

Releasing the tray from the support is subject matter of claim 17. A plurality of trays may be provided (claim 8). Also in this case, the individual deposit means for the cup is configured such that it holds the cup(s) above the subsurface so that the cup(s) do not need to be placed on the subsurface. Cup and subsurface have a distance dimension which is substantially dependent on the distance of the support structure from the lower end of the mandrel and the depth of insertion or turning in.

If performing the procedure of connecting the tray-like deposit means with the mandrel in the other direction is regarded as a releasing action (the alternative according to claim 15), the inverse direction of movement for the tray-like deposit means is obtained. The fixing is released which can be achieved by an axial upward movement of the tray-like deposit means, whereupon the tray is removed from the mandrel and can be stored separately.

The mandrel is substantially straight. Its front end is adapted for inserting or turning in and the horizontally extending support structure, which is adapted as a support for the tray-like deposit means (and is thus also suitable for this purpose), is located above the lower section (claim 11). The tray-like deposit means comprises the opening which is guided over the upper section of the mandrel for attachment. For releasing the tray, the opening is removed from the mandrel in the opposite direction. When attached, the horizontal structure supports the tray-like deposit means (claim 12). It rests upon it. It is may be fixed thereto so that it cannot be pushed further downwards in the axial direction of the mandrel.

The system may also be made of one piece (claim 9), wherein the tray-like deposit means and the mandrel are firmly connected to each other. The firm connection is a synonym of a fabrication from one piece of one material or of a permanent connection so that lifting off and attaching the tray-like deposit means is precisely not possible, rather the deposit means can be removed from the subsurface and inserted or turned into the subsurface as a whole (tray and mandrel) only.

The horizontally extending support structure may have a ring shape (claim 12). The ring shape has a ring plane which has a supporting effect on the tray-like deposit means. If the tray-like deposit means is slid over the upper section in a downward direction, the tray-shaped deposit means (in short: tray) comes to rest on the horizontally extending support structure and sits there in such a stable position that it rests stably thereon without the need for further screwing or adhesive fasteners. A minimum extension of this ring shape provides the tray-shaped deposit means with greater stability (claim 13). If the outside of the ring shape is at least 40% of the diameter of the tray-shaped deposit means, the tray may sit stably thereon. In addition, it is supported by the upper section which extends upwards on the inside and preferably tapers in an upward direction (claim 14). This corresponds to an expansion (broadening) in a downward direction. Seen the other way round, the lower section of the mandrel may expand (broaden) in an upward direction, in fact more pronounced and to a greater extent than the upper section expands in the downward direction.

Thus, a step is created where the tray is attached, said step having the ring shape and being horizontally plane at the top.

The dimensions of the two ends, i.e. the lower end of the upper section and the upper end of the lower section, are not identical (e.g. in diameter), whereby the annular step is formed.

The tray rests on the, in particular, annular step of the mandrel which is composed of an upper section and a lower section.

In addition, the upper section may be decorated by comprising a handle knob at the upper end (claim 15). However, the decoration is not mere decoration only, but also has a handling function, i.e. ease of grip of the mandrel, in case a cross-shaped structure for holding and turning in or inserting is not provided. Due to the fact that the is handle knob forms the upper end, provision of a thread at the upper section of the mandrel does not make sense (claim 16), via which thread a tray would be screwed on or a tray attached to the support structure would be fastened by a separate nut (a screw fixing means). The invention can do without a thread (claim 16).

The components of the single-leg deposit means (claim 1) or the individually positionable deposit means (claim 11) comprise the tray-shaped deposit means (claim 18) and the substantially straight mandrel (claim 22).

The tray-shaped deposit means comprises an opening which is preferably centrally aligned and the axis of which forms the center axis of said tray-shaped deposit means. The opening is adapted and configured to be guided over the upper section of the straight mandrel. The deposit means comprises a number of tubular inserts which are circumferentially distributed. The circumferential distribution is oriented towards said center axis. If the tray is round in shape, the circumferential distribution may also be determined according to a uniform spacing from an edge of the surface area of the tray. Each one of the tubular inserts is configured to receive one drinking vessel each, wherein the inserts each have a base. The base holds the drinking vessel and supports the drinking vessel placed in the insert, respectively.

A plurality of said tray-shaped deposit means can be stacked on top of each other in the state removed from the mandrel, wherein the tubular inserts come to sit in each other. Preferably, they are conical in shape (claim 21). The bases of the inserts may have a sieve-like configuration so that water (or spilt drinks) may drain off (claim 19). A low number of hole-shaped apertures in the base of a respective tubular insert are sufficient.

A tubular insert may be provided, the base of which is not perforated (claim 20). It is configured and adapted for use as an ashtray.

The other component of the deposit means according to any one of claim 1 or 11 is the substantially straight mandrel (claim 22). It comprises an upper section and a lower section. The lower end section of the lower section is adapted to be turned or inserted into the subsurface, however, only to a small extent. Measured from the lowermost end, the substantially straight mandrel comprises a horizontally extending support structure at a specific height above this lower end. This support structure is located at the upper end of the lower section. This support structure is formed in the horizontal direction. Thus, it is adapted for receiving and supporting a tray-shaped deposit means is for holding (supporting) this tray-shaped deposit means at a constant axial height.

The horizontally extending support structure preferably has a ring shape (claim 27). The horizontal extension is determined according to the vertical axis of the substantially straight mandrel and corresponds to a plane extending perpendicularly to this axis.

In addition, the ring shape of the horizontally extending support structure can comprise laterally extending arms. Said arms also have a horizontal surface which is a component part of the horizontally extending support structure.

The upper section may broaden in the downward direction (claim 23). The lower section may also broaden in the upward direction. The respective final thicknesses of the upper section and the lower section are not identical so that a step is formed, which is a component part of the horizontally extending structure. This step may have the said ring shape lying in the horizontal plane which extends perpendicularly to the vertical axis of the substantially straight mandrel.

Said two expansions may preferably be rotationally symmetrical, i.e. may be interpreted in the manner of a circle having a radius increasing in the upward direction for the lower section and increasing in the downward direction for the upper section. Then a shape having continuous expansions, without formation of intermediate steps, is obtained. However, a single step remains which is a component part of the horizontal support structure and is located between the two largest radial dimensions of the two sections (claim 28).

An operating handle, in particular a handle knob, can be provided at the upper end of the upper section (claim 24). It has a diameter which is at least smaller, preferably considerably smaller, than the opening the tray-like deposit means comprises for being slid over the upper section in order to be able to rest on the horizontally extending support structure.

If the handle knob is provided, a thread at the upper section of the mandrel does not make sense (claim 15). It is thus free of thread.

If a dimension of the horizontally extending structure relating to the ring shape is to be indicated, said dimension is in any case greater than the horizontal dimension of the is radially expanding operating handle (claim 26). The radial external dimension of the ring shape is preferably even twice the size of the greatest dimension of the radially expanding operating handle.

If the operating handle is spherical and the horizontally extending support structure has the shape of a circular ring, the greatest diameter of the support structure is greater than twice the spherical diameter of the handle knob. This is shown in a preferred example of shapes.

The Figures describe examples of the invention. One-piece and two-piece systems are disclosed.

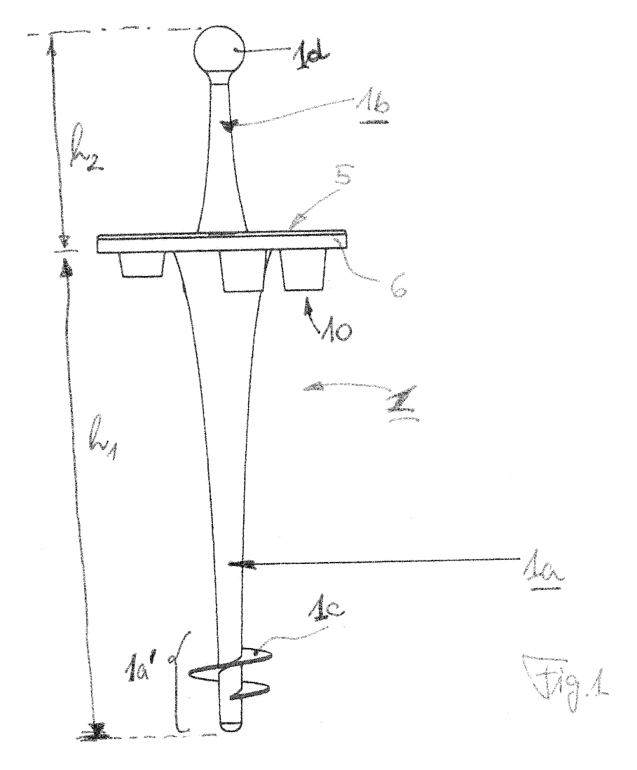

FIG. 1 shows, in side view, a deposit means provided with a single leg only and comprising a mandrel 1, a tray-like deposit means 5 and receptacles 10 for drinking vessels arranged therein.

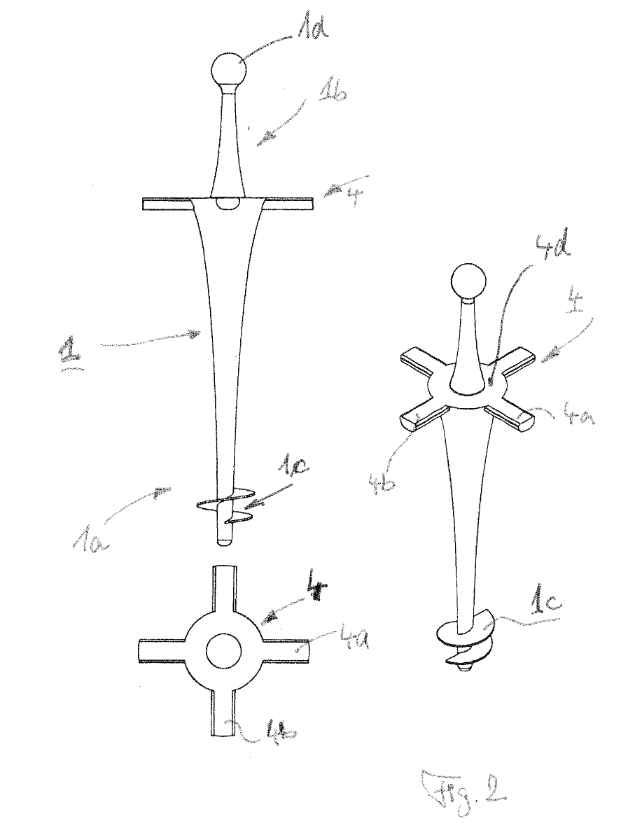

FIG. 2 shows, in side, plan and perspective view, the arrangement of FIG. 1 without the tray-like deposit means 5, i.e. with the tray-shaped deposit means 5 removed in the upward direction, so that a cross-shaped

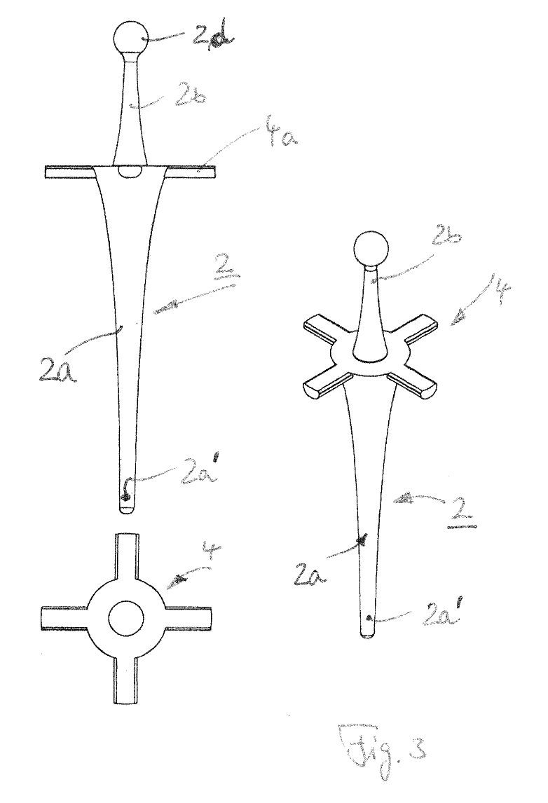

FIG. 3 shows the deposit means provided with a single leg without the spiral 1c for a different subsurface. Also in this case, the tray 5 has been removed. It can be attached and removed.

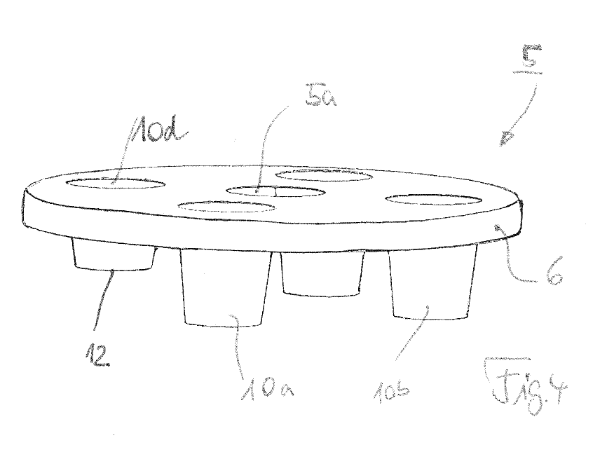

FIG. 4 shows the removed tray 5 having a substantially central opening 5a.

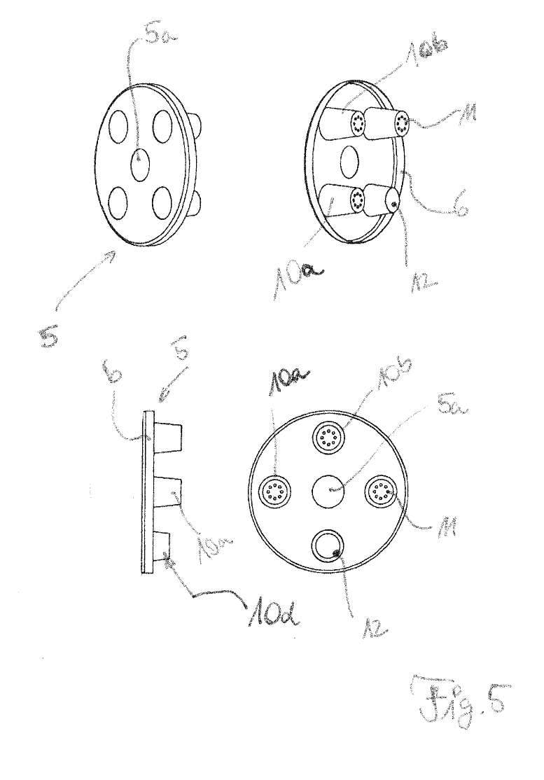

FIG. 5 shows a number of views of the tray 5 in perspective, side and bottom view. The tubular recesses 10 having a sieve-like structure 11 at the base 12 for draining off water are apparent therein.

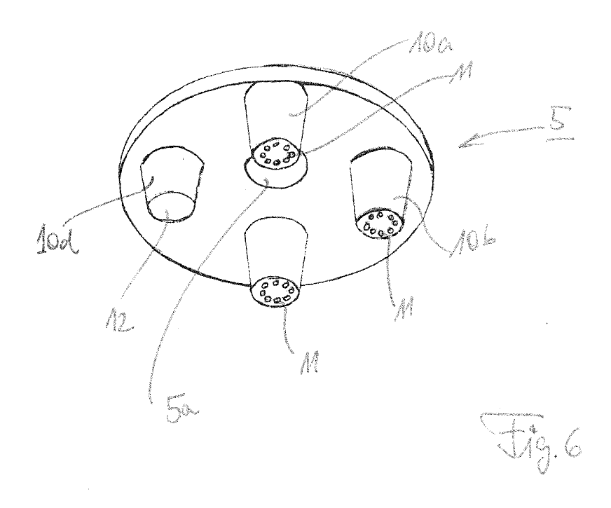

FIG. 6 shows a further enlarged view of the tray-shaped deposit means 5 in which a recess 10d not perforated at the base 12 is apparent on the left which may be used as an ashtray.

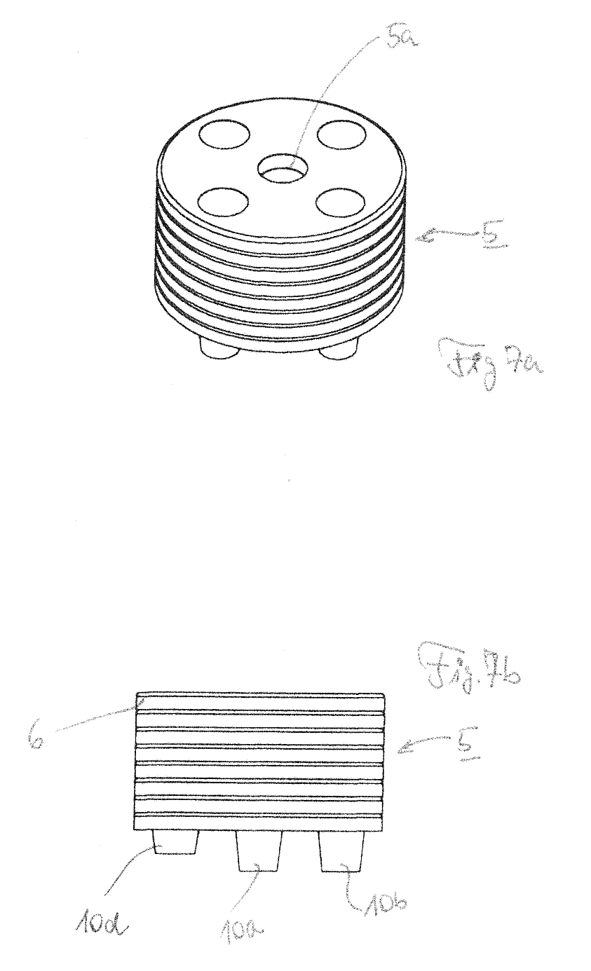

FIG. 7a FIG. 7b show a plurality of stacked tray-shaped deposit means 5, wherein the respective openings 5a are arranged centrically on top of each other. Due to the edge 6, the tray-shaped deposit means 5 are centered with respect to each other on a stack and can be lifted off individually.

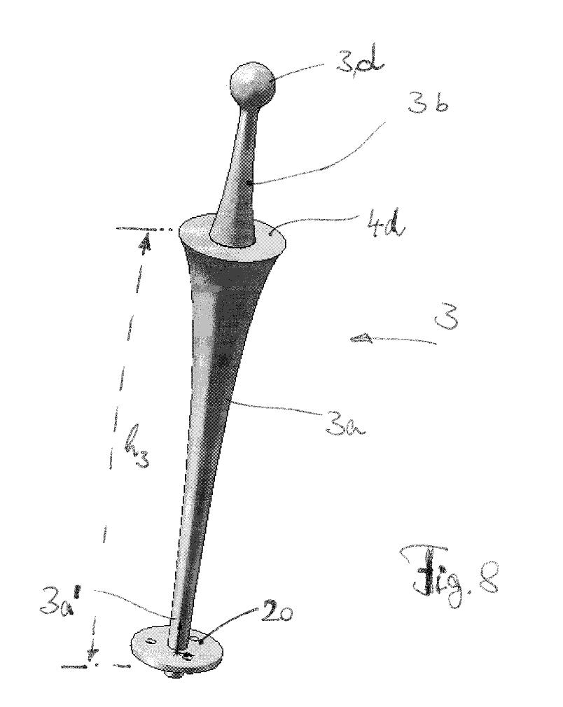

FIG. 8 is a further example of the invention.

### TWO-PIECE SYSTEM

A mandrel 1 provided with a spiral (worm 1c) at the lower end section 1a′ and having an upper section 1b and a handle 1d or a straight insert mandrel 2 having a handle 2d at the upper end and a straight lower end section 2a′ adapted for insertion is provided. The mandrel 1 or 2 comprises a cross-shaped corpus 4 having arms 4a, 4b etc., wherein said corpus 4 may serve as a turning-in aid and as a support for a tray-like deposit means 5.

The handle 1d or 2d may be spherical in shape.

The tray-shaped deposit means 5 has an opening 5a and can be attached to the cross-shaped corpus 4 with its edge 6 facing downwards. The cross is then located within the edge 6 of the “tray” in an accurately fitting manner. The upper section 1b or 2b of the mandrel 1 or 2 extends through the opening 5a. The cross structure 4a, 4b is arranged on the mandrel 1 at a height h₁ from the bottom or h₂ from the top.

In the example, the deposit means 5 is provided with a (freely) selectable number of tubular inserts 10a, 10b, etc. (generally indicated by 10) for drinking vessels, which inserts preferably have a sieve-like structure 11 on the bottom side for draining off condensed water. An ashtray-like disposal option 10d for tobacco products may be provided in the tray-shaped deposit means 5. This disposal option may be recessed or is composed of a shallow tube which is alternatively capable of receiving a drinking vessel. The base 12 thereof is not perforated.

The tubular inserts 10a, 10b etc. may also be conical in shape, as shown, in order to be stackable; just as the disposal tube for tobacco products.

Assembly or erection is performed as follows:

Firstly, the insert mandrel 1 (or 2) is turned or inserted into the ground as a support at an arbitrarily chosen position. Then, the deposit means 5 with its (in most cases central) opening 5a is guided over the insert mandrel as the support and is fixed at a specific height h₁ by placement on the accurately fitting cross-shaped structure 4. The accurately fitting cross-shaped structure is a horizontally extending structure which may comprise a plurality of arms. It may also be comprised of a plain annular plate section 4d not having any arms, however, extending horizontally and providing a bit of a horizontal surface on which the tray may be placed (after the opening 5a has been guided over the upper section 1b), cf. FIG. 8.

The fixing is achieved (preferably when there are four arms) by applying the downward extending edge of the tray on the outer edge of the respective arm. Thus, the tray-shaped deposit means is centered on and is fixed to the circular support structure 4a, 4b (and others) in an accurately fitting manner.

The accurately fitting fixing is releasable and the tray may be removed in the vertical direction.

The insert mandrel or turn-in mandrel may stay in place, while the tray can be taken along and stored elsewhere. It may also be stacked which is aided by the circumferential edge 6, cf. the following.

A completely continuous edge 6 is not required, rather only such an edge is to be considered advantageous that is associated with the respective cross-shaped structure or that comprises a piece of a downward projecting edge extending towards a respective end of an arm of the cross structure.

Thus, a safe connection of the two pieces is created so that an accidental bump will not cause anything to tip over. Generally speaking, a tray-shaped deposit means is coupled to a support, wherein said deposit means can be fixed to the support and released therefrom. The deposit means 5 has a number of inserts for drinking vessels. This is the two-piece structure.

The surface finish (profiling, cant or the like) of the support as the mandrel 1 or 2 can be fashioned in accordance with individual needs.

After the end of the bathing activity (or for disassembly), the service staff can easily remove the tray-shaped deposit means 5 (from the support) by lifting it off.

The tray-shaped deposit means 5 can then be emptied, cleaned or the like. It does not need to be put back on the support; the deposit means 5 may rather be stored in a stack—similar to beach loungers—until they are reused. They may also be stored remote from the mandrel 1 or 2.

Another two-piece system is shown in FIG. 8, wherein only the mandrel is shown in this Figure, however, in perspective view, corresponding to the mandrel 1 of FIG. 2. This mandrel 3 comprises a lower section 3a and an upper section 3b. The lower section 3a has a lower end section 3a′ inserted into a receptacle 20 which may be mounted in a firm ground. In a respective design corresponding to FIG. 1, a spiral designed in accordance with the spiral 1c of FIG. 1 can be attached in section 3a′ without using the receptacle 20.

The horizontal support structure 4d is capable of supporting the tray 5 when the tray is slid over the upper section 3b and downwards coming to rest upon the support ring 4d as the horizontal support structure at a height h₃. The diameter of the opening 5a of the tray 5 corresponds to the greatest extension of the upper section 3b, and if, in addition, a handle 3d is provided, the opening 5a has at least the extension corresponding to the external dimension of the handle 3d, in particular when in the shape of a sphere, cf. FIG. 4.

The horizontal support structure 4d may be interpreted as a step at the height h₃ which is created when an upwards expanding lower section 3a and a downwards expanding upper section 3b are present. The respective ends, which converge in the horizontal support structure 4d, are not identical in size, but differ considerably, as shown in FIG. 8 and as already shown in the side view of FIG. 1.

The broadening of each of the two sections towards the horizontal support structure 4d, which has a ring shape in FIG. 8, is continuous in the example, i.e. has no edges or steps or potential threads. Only a support step 4d as the horizontal support structure is created having, for example, a minimum dimension in order to reliably fulfill the support function for the tray-like deposit means 5. Thus, it is at least 40% of the external diameter of the tray-shaped deposit means 5 in width. If the dimensions of the horizontal support structure are designed in this way, no additional arm 4a, 4b for further support of the tray is required. The ring-shaped step of the said width is then sufficient. The width corresponds, for example, to the external diameter of the ring 4d. The internal diameter is determined by the width of the upper section 3b at its lower is end.

For attachment, the tray is moved over the upper section 3d, 3b from above downwards and is placed on the horizontal support structure 4d. For removal, this movement is performed in the inverse direction and the tray is removed upwards from the horizontal support structure over the upper section 3b, 3d.

As to the design or various designs of the tray-like deposit means 5, it is referred to the previous Figures. Said designs can be readily applied to the mandrel 3 of FIG. 8. The diameter of the opening 5a is to be adapted to the dimension of the lower diameter of the upper section 3b of the mandrel 3 and the handle 3d of the mandrel 3 of FIG. 8 must not be greater than the diameter of the opening 5a of the tray-like deposit means 5.

### ONE-PIECE SYSTEM

In the one-piece system, the insert mandrel 1 or 2 and the tray-shaped deposit means 5 are already firmly connected to each other or are made of one piece (not shown).

This system is particularly suited for locations having predetermined positions for beach loungers.

1. An individually positionable single-leg deposit device adapted as a cup holder above a sandy subsurface provided as a two-piece system, comprising:
a substantially straight mandrel (1, 2) having:
an upper section and a lower section, said lower section (1a) being adapted for turning or inserting into the sandy subsurface (1c); and
a cross-shaped structure (4; 4a, 4b) at a given height above the lower section, said cross-shaped structure being adapted as a support for a tray-like deposit device (5); and
the tray-like deposit device comprising an opening (5a) that is adapted to be guided over the upper section (1b) of the mandrel so as to rest on and be fixable to the cross-shaped structure (4a, 4b).

2. The deposit device according to claim 1, wherein the lower section (1a) of the mandrel is provided with a spiral (1c) at a lower end section (1a′) thereof.

3. The deposit device according to claim 1, wherein the cross-shaped structure (4) is configured as both a turning-in or insertion aid and a support for the tray-like deposit device (5).

4. The deposit device according to claim 1, wherein the tray-like deposit device (5) is fixable to the cross-shaped structure (4) by a downward facing edge (6).

5. The deposit device according to claim 1, wherein the tray-like deposit device (5) is provided with a downward facing edge (6) and comprises at least one tubular insert (10) for a corresponding drinking vessel.

6. The deposit device according to claim 1, wherein the tray-like deposit device (5) is provided with a downward facing edge (6) and comprises an ashtray (10d).

7. The deposit device according to claim 5, wherein the at least one tubular insert has a sieve-like base structure (11) for draining off a liquid.

8. The deposit device according to claim 1, wherein a plurality of tray-like deposit devices (5) are provided which are adapted to be stacked on top of each other in a state not attached to the mandrel.

9. An individually positionable single-leg deposit device having a cup holder (10) for a subsurface, wherein said deposit device is configured as one of a one-piece system and an integral system having a mandrel (1, 2) comprising a lower section (1a), an end section of which is configured and adapted for turning or inserting into the subsurface, and which is one of:
firmly connected to a tray-like deposit device (5) above the lower section (1a); and
made of one piece.

10. The deposit device according claim 9, wherein the mandrel (1) comprises a downward taper, which comprises a spiral (1c).

11. An individually positionable deposit device adapted as a cup holder above a subsurface and having a two-piece system comprising:
a substantially straight mandrel (1, 2, 3) having:
an upper section and a lower section, said lower section (1a, 3a) being adapted for turning or inserting into the subsurface (1c; 3a′, 2a′); and
a horizontally extending structure (4, 4d) at a given height (h₁, h₃) above an end of the lower section, said horizontally extending structure being adapted as a holding support for a tray-like deposit device (5); and
the tray-like deposit device comprising an opening (5a) that is guidable over the upper section (1b) of the mandrel (1, 2, 3) so as to rest on and be supported by the horizontally extending structure.

12. The deposit device according to claim 11, wherein the horizontally extending structure (4d) has a ring shape.

13. The deposit device according to claim 12, wherein the ring-shaped horizontally extending structure (4d) has an external diameter which amounts to at least 40% of a diameter of the tray-like deposit device (5).

14. The deposit device according to claim 1, wherein the upper section (1b, 3b) of the mandrel broadens in the downward direction and the lower section (1a, 3a) of the mandrel broadens in the upward direction, whereby a final thickness of each of the respective sections is not identical and forms a step (4d).

15. The deposit device according to claim 1, further comprising a radially expanding operating handle at an upper end of the upper section (1b, 2b, 3b) of the mandrel.

16. The deposit device according to claim 15, wherein the upper section (1b, 2b, 3b) of the mandrel does not have a thread.

17. A method for releasing or connecting a tray from/to a mandrel (1, 2, 3), wherein the tray (5) is attached to or removed from a horizontal support structure (4d; 4; 4a) via an upper section (1b, 3b) of the mandrel.

18. The deposit device according to claim 1, wherein the tray-like deposit device is provided with at least one tubular insert (10a, 10b) adapted for a corresponding drinking vessel, wherein each tubular insert has its own base (12).

19. The deposit device according to claim 18, wherein the base (12) of at least one of the tubular inserts (10) has a sieve-like configuration for draining off water.

20. The deposit device according to claim 18, wherein a recess (10d) not perforated at a base thereof is provided as an ashtray on the tray-like deposit device.

21. The deposit device according to claim 18, wherein the tubular inserts are circumferentially distributed and at least one of the tubular inserts (10) is conical in shape.

22. The deposit device according to claim 1, wherein:
said lower section (1a, 2a, 3a) of the mandrel is adapted for turning or inserting into the subsurface bit by bit (1c; 3a′, 2a′);
said cross-shaped structure comprises a horizontally extending support structure (4, 4d) at a specific height (h₁, h₃) above a lower end of the lower section of the mandrel; and
said horizontally extending support structure (4, 4a; 4d) is configured and adapted as a holding support for the tray-like deposit device (5) for axially supporting the tray-like deposit device at a constant height.

23. The deposit device according to claim 22, wherein the upper section (1b, 2b, 3b) of the mandrel broadens in the downward direction and the lower section (1a, 2a, 3a) of the mandrel broadens in the upward direction, wherein final thicknesses of the two sections are not identical and form a step (4d) as a component part of the horizontally extending support structure (4, 4d).

24. The deposit device according to claim 22, further comprising a radially expanding operating handle comprising a handle knob (1d, 2d, 3d) at an upper end of the upper section (1b, 2b, 3b) of the mandrel.

25. The deposit device according to claim 24, wherein the upper section (1b, 2b, 3b) of the mandrel does not have a thread.

26. The deposit device according to claim 24, wherein the horizontally extending support structure (4d) has a ring shape (4d) having an external dimension greater than an external dimension of the handle knob (1d, 2d, 3d).

27. The deposit device according to claim 22, wherein the horizontally extending support structure (4d) has a ring shape with laterally extending fixing arms (4a, 4b)

28. The deposit device according to claim 23, wherein expansions defined by the broadening of the upper and lower sections of the mandrel are continuous without forming any steps, such that the only step (4d) is the step between the greatest radial dimensions of the respective upper and lower sections of the mandrel.

29. The deposit device according to claim 6, wherein the at least one tubular insert has a sieve-like base structure (11) for draining off a liquid.

30. The deposit device according to claim 12, wherein the ring-shaped horizontally extending structure (4d) has laterally extending fixing arms (4a, 4b).

31. The deposit device according to claim 11 wherein the upper section (1b, 3b) of the mandrel broadens in the downward direction and the lower section (1a, 3a) of the mandrel broadens in the upward direction, whereby final thicknesses of each of the two respective sections are not identical and form a step (4d).
